(19) United States
(12) Patent Application Publication
(10) Pub. No.: US 2014/0003364 A1
(43) Pub. Date: Jan. 2, 2014

(54) METHOD AND APPARATUS FOR IMPROVING CALL SETUP PERFORMANCE

(71) Applicant: QUALCOMM INCORPORATED, San Diego, CA (US)

(72) Inventors: Shyamal Ramachandran, San Diego, CA (US); Thomas Klingenbrunn, San Diego, CA (US); Salil Sawhney, San Diego, CA (US); Uttam Pattanayak, San Diego, CA (US); Abhishek Bhatnagar, San Diego, CA (US); Mutaz Zuhier Afif Shukair, San Diego, CA (US); Chunchung Chan, Hong Kong (HK); Bhupesh Manoharlal Umatt, Poway, CA (US)

(73) Assignee: QUALCOMM INCORPORATED, San Diego, CA (US)

(21) Appl. No.: 13/800,998

(22) Filed: Mar. 13, 2013

Related U.S. Application Data
(60) Provisional application No. 61/666,440, filed on Jun. 29, 2012.

(51) Int. Cl. H04W 76/02

(52) U.S. Cl. CPC H04W 76/026
USPC 370/329

(57) ABSTRACT

Certain aspects of the present disclosure relate to methods and apparatus for improving call setup performance. In certain aspects, a User Equipment (UE) or a network servicing the UE, may detect at least one of the occurrence or anticipated occurrence of circuit switched (CS) signaling by a user equipment (UE), wherein the CS signaling at least comprises signaling associated with a CS call setup procedure, suspend packet-switched (PS) signaling or processing of such PS signaling in order to avoid delaying circuit-switched (CS) signaling, at least until the PS signaling may not substantially effect CS domain activity. In an aspect, a progress of a CS call setup procedure may be monitored and the PS signaling or processing of such PS signaling may be resumed based on completion of a radio bearer setup step in the CS call setup procedure.

### CLAIM OF PRIORITY UNDER 35 U.S.C. §119

The present application for patent claims priority to U.S. Provisional Application No. 61/666,440, entitled “METHODS AND APPARATUS FOR IMPROVING CALL SETUP PERFORMANCE,” filed Jun. 29, 2012, and assigned to the assignee hereof and hereby expressly incorporated by reference herein.

### FIELD

The present disclosure relates generally to communication systems, and more particularly, to methods and apparatus for improving call setup performance.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method of wireless communications by a User Equipment (UE). The method generally includes detecting at least one of the occurrence or anticipated occurrence of circuit-switched (CS) signaling by the UE, wherein the CS signaling at least comprises signaling associated with a CS call setup procedure, suspending packet-switched (PS) signaling by the UE in response to the detection, monitoring progress of the CS call setup procedure, and resuming the PS signaling on completion of a radio bearer setup step in the CS call setup procedure.

Certain aspects of the present disclosure provide an apparatus for wireless communications by a User Equipment (UE). The apparatus generally includes means for detecting at least one of the occurrence or anticipated occurrence of circuit-switched (CS) signaling by the UE, wherein the CS signaling at least comprises signaling associated with a CS call setup procedure, means for suspending packet-switched (PS) signaling by the UE in response to the detection, means for monitoring progress of the CS call setup procedure, and means for resuming the PS signaling on completion of a radio bearer setup step in the CS call setup procedure.

Certain aspects of the present disclosure provide an apparatus for wireless communications by a User Equipment (UE). The apparatus generally includes at least one processor and a memory coupled to the at least one processor. The at least one processor is generally configured to detect at least one of the occurrence or anticipated occurrence of circuit-switched (CS) signaling by the UE, wherein the CS signaling at least comprises signaling associated with a CS call setup procedure, suspend packet-switched (PS) signaling by the UE in response to the detection, monitor progress of the CS call setup procedure, and resume the PS signaling on completion of a radio bearer setup step in the CS call setup procedure.

Certain aspects of the present disclosure provide a computer program product for wireless communications by a User Equipment (UE). The computer program product generally includes a computer-readable medium comprising code for detecting at least one of the occurrence or anticipated occurrence of circuit-switched (CS) signaling by the UE, wherein the CS signaling at least comprises signaling associated with a CS call setup procedure, suspending packet-switched (PS) signaling by the UE in response to the detection, monitoring progress of the CS call setup procedure, and resuming the PS signaling on completion of a radio bearer setup step in the CS call setup procedure.

Certain aspects of the present disclosure provide a method for wireless communications by a Base Station (BS). The method generally includes detecting at least one of the occurrence or anticipated occurrence of circuit switched (CS) signaling by a user equipment (UE), wherein the CS signaling at least comprises signaling associated with a CS call setup procedure, suspending processing of packet-switched (PS) signaling received from the UE in response to the detection, monitoring progress of the CS call setup procedure, and resuming processing of the PS signaling on completion of a radio bearer setup step in the CS call setup procedure.

Certain aspects of the present disclosure provide an apparatus for wireless communications by a Base Station (BS). The apparatus generally includes means for detecting at least one of the occurrence or anticipated occurrence of circuit switched (CS) signaling by a user equipment (UE), wherein the CS signaling at least comprises signaling associated with a CS call setup procedure, means for suspending processing of packet-switched (PS) signaling received from the UE in response to the detection, monitoring progress of the CS call setup procedure, and means for resuming processing of the PS signaling on completion of a radio bearer setup step in the CS call setup procedure.

Certain aspects of the present disclosure provide an apparatus for wireless communications by a Base Station (BS). The apparatus generally includes at least one processor and a memory coupled to the at least one processor. The at least one processor is generally configured to detect at least one of the occurrence or anticipated occurrence of circuit switched (CS) signaling by a user equipment (UE), wherein the CS signaling at least comprises signaling associated with a CS call setup procedure, suspend processing of packet-switched (PS) signaling received from the UE in response to the detection, monitor progress of the CS call setup procedure, and resume processing of the PS signaling on completion of a radio bearer setup step in the CS call setup procedure.

Certain aspects of the present disclosure provide a computer program product for wireless communications by a Base Station (BS). The computer program product generally includes a computer-readable medium comprising code for detecting at least one of the occurrence or anticipated occurrence of circuit switched (CS) signaling by a user equipment (UE), wherein the CS signaling at least comprises signaling associated with a CS call setup procedure, suspending processing of packet-switched (PS) signaling received from the UE in response to the detection, monitoring progress of the CS call setup procedure, and resuming processing of the PS signaling on completion of a radio bearer setup step in the CS call setup procedure.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a diagram illustrating a wireless communication network, in accordance with certain aspects of the present disclosure.

FIG. 2 shows a diagram illustrating an access network, in accordance with certain aspects of the present disclosure.

FIG. 2A shows a frame structure used in LTE in accordance with certain aspects of the present disclosure.

FIG. 3 shows a block diagram conceptually illustrating an example of a evolved Node B in communication with a user equipment device (UE) in a wireless communications network in accordance with certain aspects of the present disclosure.

FIG. 4 shows a diagram illustrating a call flow for a call setup process in a communication system, in accordance with certain aspects of the present disclosure.

FIG. 5 shows a diagram illustrating a call flow for a call setup process in the communication system, in accordance with certain aspects of the present disclosure.

FIG. 6 illustrates example operations performed by a user equipment (UE) for improving call setup performance, in accordance with certain aspects of the present disclosure.

FIG. 7 illustrates example operations performed by a Base Station (BS) for improving call setup performance, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented utilizing electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The techniques described herein may be utilized for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is utilized in much of the description below.

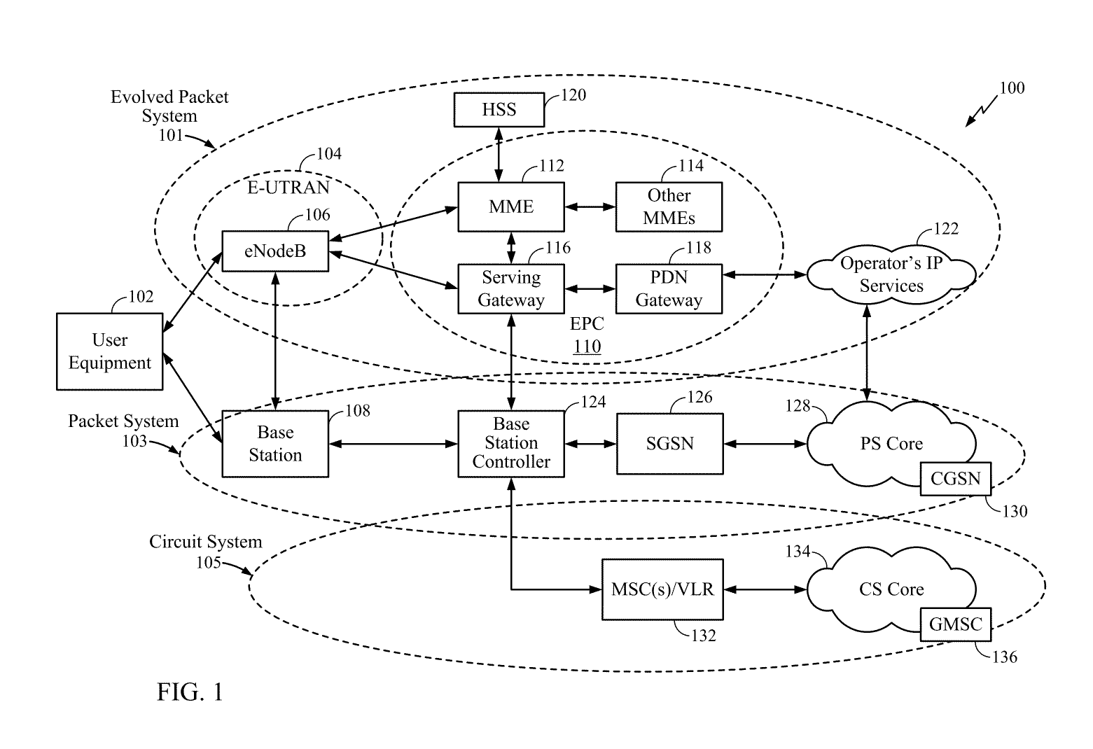

FIG. 1 shows a diagram illustrating a wireless network architecture 100 employing various apparatuses, in accordance with aspects of the disclosure. The network architecture 100 may include an Evolved Packet System (EPS) 101. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS may interconnect with other access networks, such as a packet switched core (PS core) 128, a circuit switched core (CS core) 134, etc. As shown, the EPS provides packet-switched services, however, as those skilled in the art will readily appreciate, the various concepts presented throughout this disclosure may be extended to networks providing circuit-switched services, such as the network associated with CS core 134.

The network architecture 100 may further include a packet switched network 103 and/or a circuit switched network 105. In one aspect, the packet switched network 103 may include base station 108, base station controller 124, Serving GPRS Support Node (SGSN) 126, PS core 128 and Combined GPRS Service Node (CGSN) 130. In another aspect, the circuit switched network 105 may include base station 108, base station controller 124, Mobile services Switching Centre (MSC), Visitor location register (VLR) 132, CS core 134 and Gateway Mobile Switching Centre (GMSC) 136.

The E-UTRAN may include an evolved Node B (eNB) 106 and connection to other networks, such as packet and circuit switched networks may be facilitated through base station 108. The eNB 106 provides user and control plane protocol terminations toward the UE 102. The eNB 106 may be connected to the other eNBs 108 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS).

In an aspect of the disclosure, the wireless system 100 may be enabled to facilitate circuit-switched fallback (CSFB). In an aspect, when a phone number is dialed to place a CS call, if the UE were camped on an LTE network, a CSFB procedure may be employed. The CSFB procedure may move the UE from an LTE cell to a CS based cell, such as UTRAN, GERAN, etc., where the CS call setup may occur using legacy CS call setup procedures. As used herein, CSFB may refer to establishing a signaling channel between a circuit switched MSC 132 and the LTE core network 101 to allow for services, such as voice calls, short message service (SMS), etc. In an implementation, when a UE 102 is moved from an LTE network 101 to a 3GPP network, such as a CS based network 103 (UTRAN), a packet switched (PS) network 103, etc., the UE may perform one or more registration procedures prior to being able to communicate user data over the 3GPP network.

In an aspect of the disclosure, although the description may provide examples through use of a UTRAN system, it should be appreciated that other Radio Access Technologies (RATs), such as GERAN, etc., may be used.

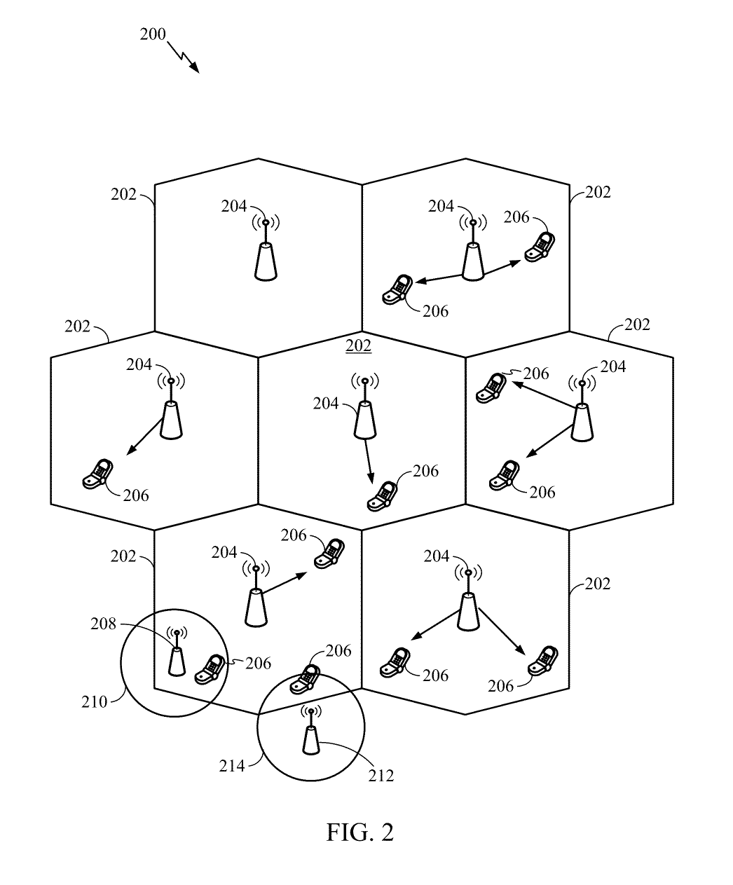

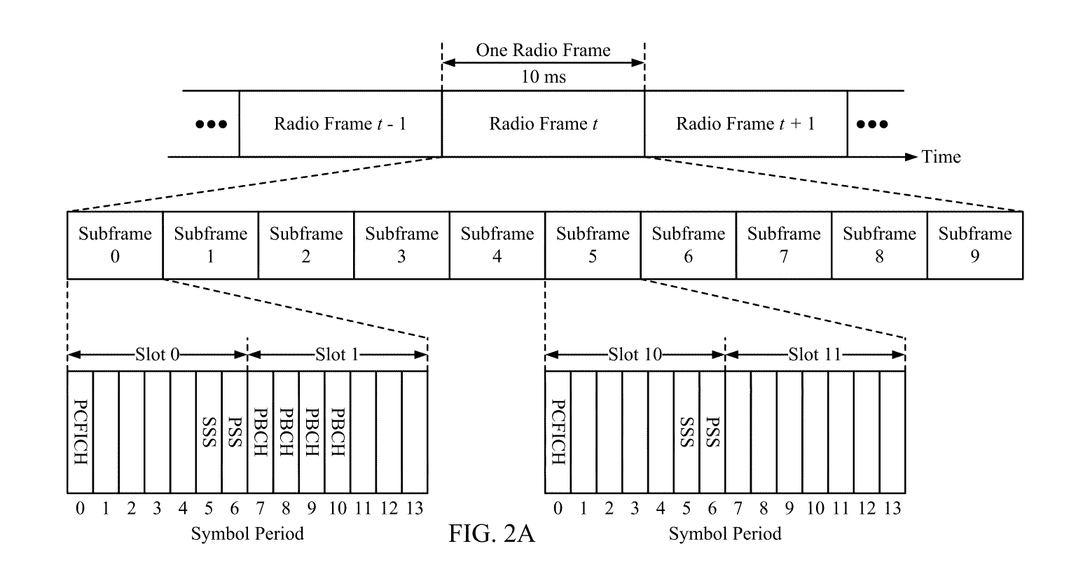

FIG. 2 shows a diagram illustrating an access network in an LTE network architecture, in accordance with aspects of the disclosure. In an example, the access network 200 is divided into a number of cellular regions (cells) 202. One or more lower power class eNBs 208, 212 may have cellular regions 210, 214, respectively, that overlap with one or more of the cells 202. The lower power class eNBs 208, 212 may be femto cells (e.g., home eNBs (HeNBs)), pico cells, or micro cells. A higher power class or macro eNB 204 is assigned to a cell 202 and is configured to provide an access point to the EPC 210 for all the UEs 206 in the cell 202. There is no centralized controller in this example of an access network 200, but a centralized controller may be used in alternative configurations. The eNB 204 is responsible for all radio related functions including radio bearer control, admission control, mobility control, scheduling, security, and connectivity to the serving gateway 116 (see FIG. 1).

In accordance with aspects of the disclosure, the modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 2rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

In an implementation, the eNB 204 may have multiple antennas supporting MIMO technology. The use of MIMO technology enables the eNB 204 to exploit the spatial domain to support spatial multiplexing, beamforming, and transmit diversity.

Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream and then transmitting each spatially precoded stream through a different transmit antenna on the downlink. The spatially precoded data streams arrive at the UE(s) 206 with different spatial signatures, which enables each of the UE(s) 226 to recover the one or more data streams destined for that UE 206. On the uplink, each UE 206 transmits a spatially precoded data stream, which enables the eNB 204 to identify the source of each spatially precoded data stream.

Spatial multiplexing may be generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

FIG. 2A shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP), as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, for example, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

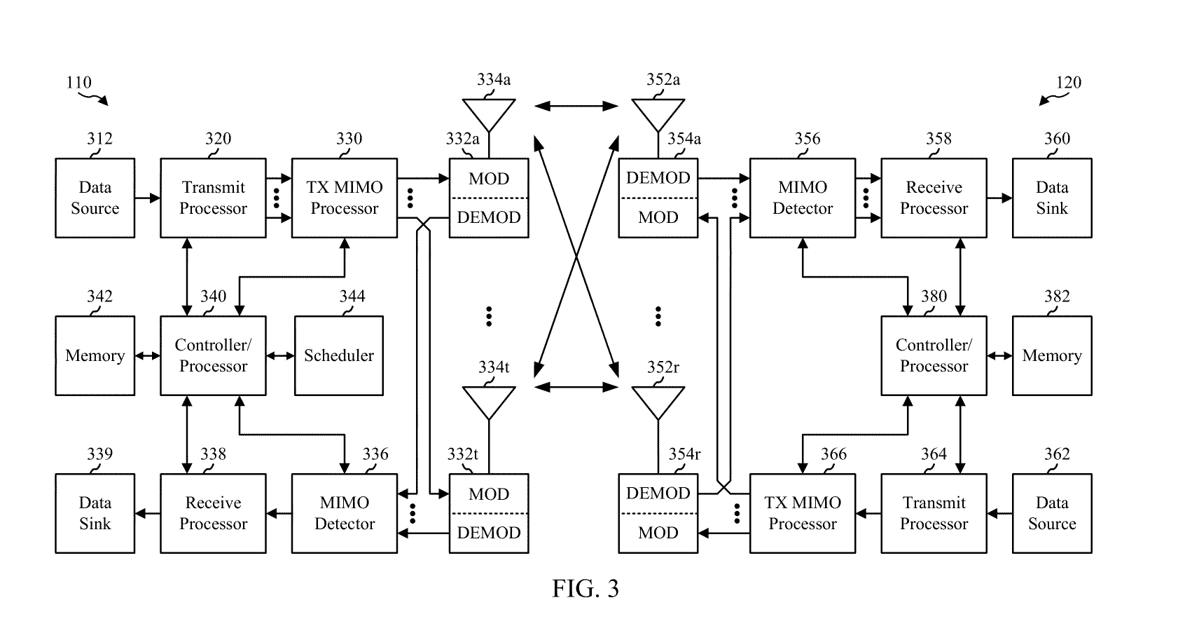

FIG. 3 shows a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by antennas 334, processed by demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

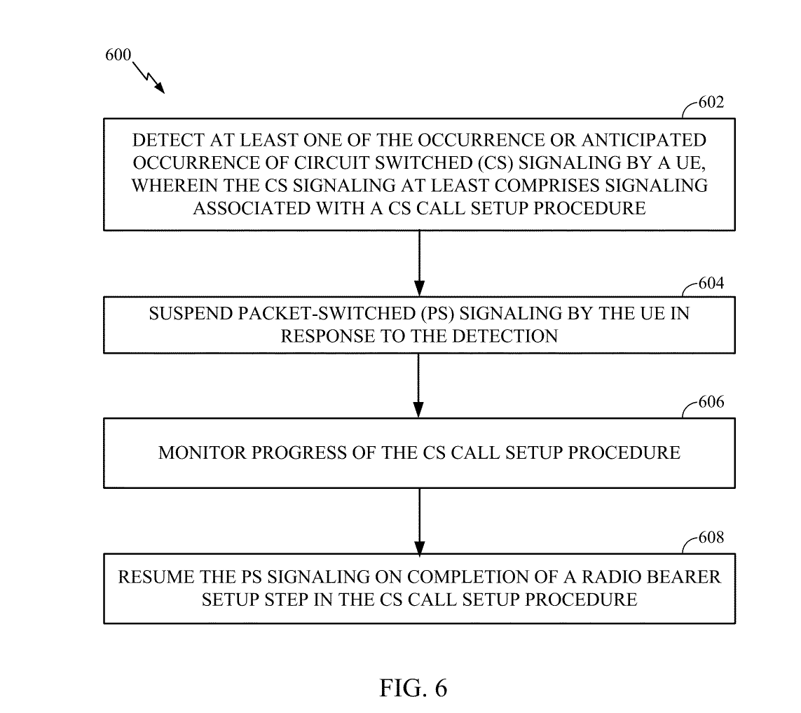

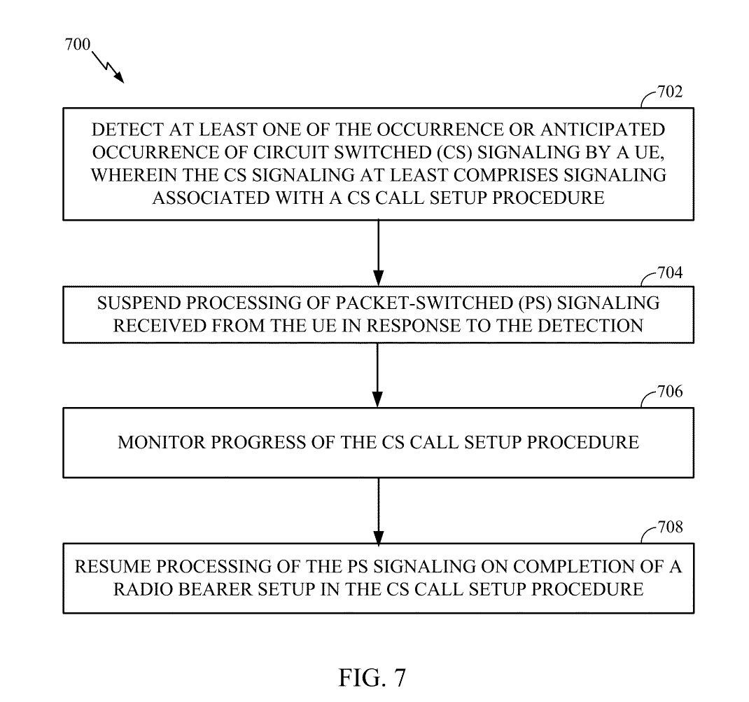

The controllers/processors 340, 380 may direct the operation at the eNB 110 and the UE 120, respectively. The controller/processor 380 and/or other processors and modules at the UE 120 may perform or direct operations for example operations 600 in FIG. 6, and/or other processes for the techniques described herein, for example. The controller/processor 340 and/or other processors and modules at the eNB 110 may perform or direct operations for example operations 700 in FIG. 7, and/or other processes for the techniques described herein, for example. In aspects, one or more of any of the components shown in FIG. 3 may be employed to perform example operations 600, 700 and/or other processes for the techniques described herein. The memories 342 and 382 may store data and program codes for base station 110 and UE 120, respectively. A scheduler 344 may schedule UEs for data transmission on the downlink and/or uplink.

### Example Method and Apparatus for Improving Call Setup Performance

In certain aspects, certain current LTE or 4G networks are pure IP networks without support for voice solutions for UEs camped on the LTE network. There is an interest in the industry to facilitate voice services on devices that are LTE and second generation (2G)/third generation (3G) capable and spend most of their time on LTE networks. CSFB (Circuit Switched Fall Back), as noted above, allows such multi radio access technology (RAT) capable UEs to make voice calls while camped on an LTE network. For certain aspects, when CSFB is supported, a UE that is camped on an LTE network and that wants to make a voice call not supported by the LTE network, may be transferred to a 2G/3G network for servicing the voice call.

In certain aspects, if a UE that is camped on LTE makes or receives a circuit-switched (CS) call, it may communicate with the LTE network and may be transitioned to a GSM or UMTS network to perform a CS call setup.

In certain aspects, while performing a CS call setup procedure, the UE may need to carry out one or more packet domain procedures. For example, the UE may have to perform a Routing Area Update (RAU) procedure for PS domain registration and/or service request procedure for resumption of any user plane data in the PS domain. In certain aspects, after an inter-RAT transfer, if the Idle Mode Signaling Reduction (ISR) is not activated the UE must perform the RAU procedure whether or not the UE has an ongoing data call. In an aspect, if the ISR is activated, the UE may omit the RAU procedure. However, the UE may have to perform the service request procedure if there is any ongoing uplink data activity.

In certain aspects, while in legacy 2G/3G networks, the possibility of CS and PS signaling occurring simultaneously is minimal. However, such parallel signaling may be highly probable, in fact, almost guaranteed with the advent of fourth generation (4G) and CSFB. Along with every CSFB call, the UE may have to perform the CS call setup, which may likely coincide with PS signaling, such as the RAU procedure and the service request procedure.

The 3GPP standard allows the UE to perform parallel CS and PS signaling in UMTS and DTM GSM NWs. The standard also mandates that the network be capable of processing these signals in parallel. However, it has been observed that multiple, distinct network implementations may result in adversely impacting CS domain signaling and related processing if PS domain signaling occurs in parallel from the same UE.

In certain aspects, the CS call setup after an inter-Radio Access Technology (RAT) transfer (e.g. from LTE to UMTS) may get delayed or in the worst case rejected/aborted/failed as a result of one or more network elements being engaged in processing any PS signaling that might also have been originated by the same UE that is performing CS call setup.

In certain aspects, in order to avoid delaying the CS domain signaling, the PS domain signaling may be suspended at least until it may not substantially affect CS domain activity. In an aspect, any NAS (Non-Access Stratum) signaling, for example, including RAU related signaling or service request related signaling may be suspended.

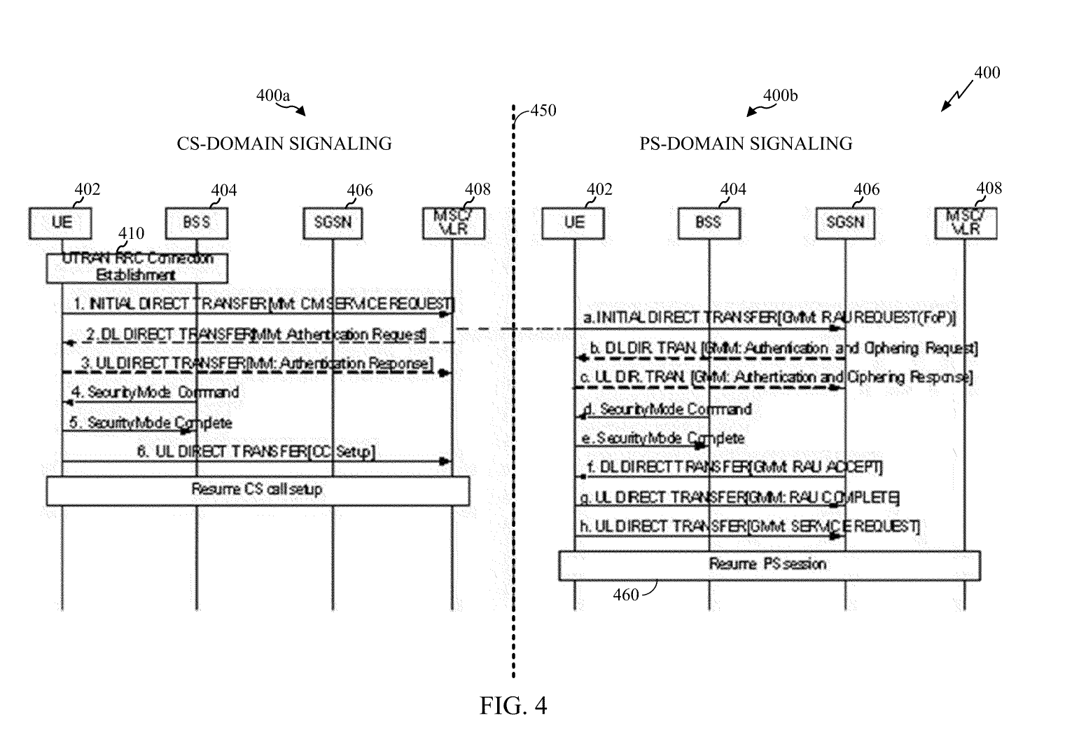

FIG. 4 shows a diagram illustrating a call flow for a call setup process in a communication system 400, in accordance with aspects of the disclosure. The communication system 400 may include a UE 402, a BSS 404, a SGSN 406, and a MSC/VLR 408. It may be noted that the below described process may be implemented on various different networks, such as UTRAN, GERAN, UMTS, GSM etc. The left hand side of vertical line 450 shows CS-domain signaling 400a and the right hand side of the vertical line 450 shows PS-domain signaling 400b. The call flow for both CS-domain and PS-domain signaling, as shown in FIG. 4, starts at a point after the UE has performed CSFB related signaling on LTE network and has been moved to and camped on the UMTS/GSM network. As shown in FIG. 4, the call flows in the CS and PS domains start after a UTRAN Radio Resource Control (RRC) connection is established at sequence step 410. Once camped on the UMTS/GSM network, the UE may have to perform a CS call setup procedure via CS domain signaling. As noted above the UE may at the same time need to perform one or more PS domain procedures such as the RAU procedure for PS domain registration and/or a service request procedure for resuming an ongoing PS session/call from the LTE network.

As shown in FIG. 4, the UE, after establishing the UTRAN RRC connection, initializes the CS call setup procedure by sending a CM SERVICE REQUEST to the CS core at step 1. Once the UE initializes the CS call setup procedure at step 1, it may also initialize the RAU procedure in the PS domain by sending a RAU request to the PS core at step a. The UE may complete the RAU procedure at step g and additionally start a service request procedure at step h for resuming a PS session at 460. In certain aspects, if the UE decides to omit the RAU procedure, it may start directly with the service request procedure at step h.

In certain aspects, ideally, the UMTS/GSM network must process the requests for executing the CS domain and PS domain signaling from the UE in parallel. However, due to network constraints such as resource constraints and/or prioritization/arbitration logic between the PS and CS core networks, the network may process the CS and PS domain requests sequentially. Thus, in certain aspects, when the UMTS/GSM network receives the RAU REQUEST from the UE 402, it may choose to continue processing the RAU procedure, thereby delaying the CS call setup procedure. For example, the network may not process the CM SERVICE REQUEST until step f or g of the RAU procedure is completed. In certain aspects, the network may introduce a delay at any point in the CS call setup procedure to prioritize processing of one or more steps in the RAU procedure. In an aspect the UE 402 may not know the precise point at which the delay in the CS call setup may occur.

In certain aspects, the UE 402 may suspend the PS domain state machine to prevent origination of any PS domain signaling. For example, the UE 402 may suspend the PS domain signaling immediately after transitioning from LTE network to UMTS/GSM network. In an alternate example, the UE 402 may suspend the PS signaling at any instance during the CS call setup procedure to avoid any further delay in the CS call setup.

In certain aspects, the UE 402 may anticipate or detect CS signaling for a CS call setup after CSFB procedure, and in response, suspend any PS signaling to the network.

In certain aspects, the UE may start a configurable timer when suspending the PS domain state machine and resume the PS domain state machine and perform any necessary PS domain signaling on expiration of the timer.

In alternative aspects, the UE 402, after suspending the PS state machine, may monitor progress of the CS call setup, and resume the PS state machine if the CS call setup has progressed to a certain point/step. For example, the UE may resume the PS signaling at a point during the CS call setup when the PS domain activity may not adversely affect the CS setup call. In an aspect, the point of resumption of the PS activity may be configurable. For example, the point of resumption of the PS activity may be configured to be the “alerting phase” in the CS call setup. However, the point of resumption may be any other point, step or instance, such as a radio bearer setup step, a connect step, etc.

In certain aspects, the network may suspend processing PS domain signaling from the UE 402 in response to detecting or anticipating CS signaling from the UE. In an aspect, the network may start a timer when suspending to process the PS signaling and may resume processing PS signaling from the UE upon expiration of the timer. In alternative aspects, the network may monitor the CS call setup procedure and resume processing the PS signaling from the UE at a pre-configured point/step in the CS call setup.

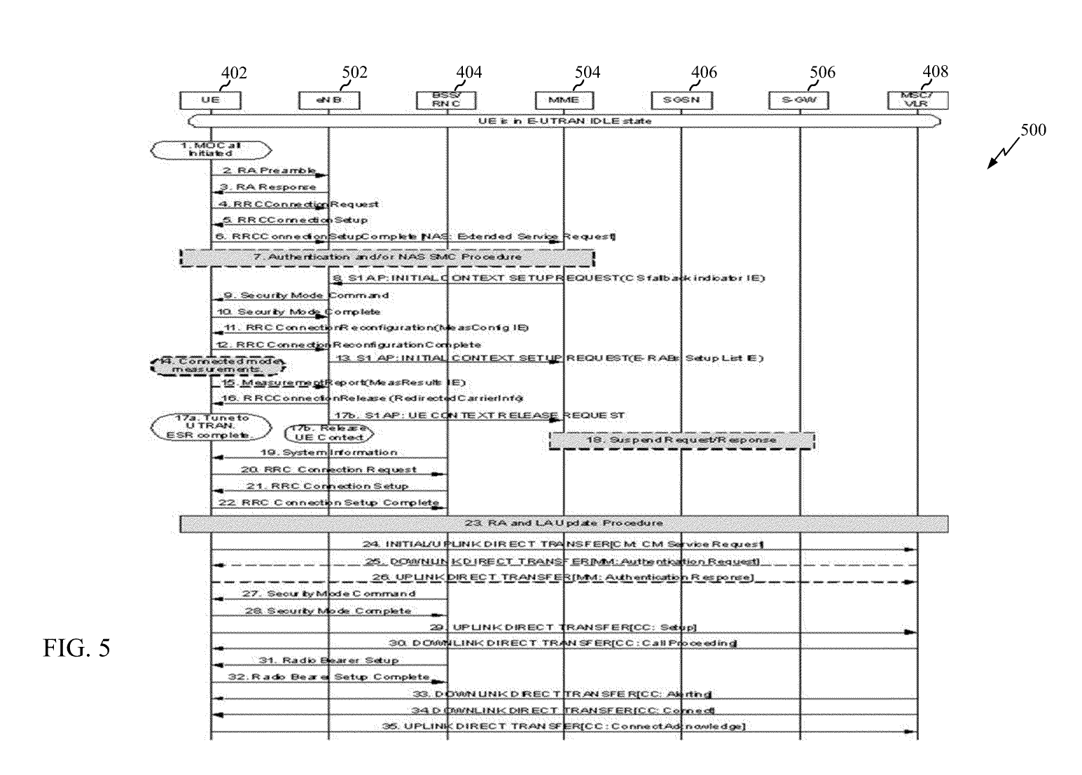

FIG. 5 shows a diagram illustrating a call flow for a call setup process in the communication system 500, in accordance with aspects of the disclosure. The communication system 500 may include a UE 402, an eNB 502, a BSS/RNC (Radio Network Controller) 404, an MME 504, a SGSN 406, an S-GW 506 and a MSC/VLR 408. Steps 1-23 include signaling for transferring the UE from the LTE network to the UMTS/GSM. CS domain steps 24-29 correspond to CS-domain steps 1-6 in FIG. 4. In certain aspects the UE may suspend the PS state machine at step 23 and resume at any of the steps 31-34, for example. As mentioned above, as an alternative, the network may suspend processing PS domain signaling from the UE 402 in response to detecting or anticipating CS signaling from the UE.

FIG. 6 illustrates example operations 600 performed by a user equipment (UE) for improving call setup performance in accordance with certain aspects of the present disclosure. Operations 600 may begin, at 602, by detecting at least one of the occurrence or anticipated occurrence of circuit-switched (CS) signaling by the UE, wherein the CS signaling at least comprises signaling associated with a CS call setup procedure. At 604, the UE may suspend PS signaling by the UE in response to the detection. At 606, the UE may monitor progress of the CS call setup procedure. At 608, the UE may resume the PS signaling on completion of a radio bearer setup step in the CS call setup procedure.

In certain aspects, the UE may determine that the UE has switched from a first RAT to a second RAT to service a CSFB call, and detect the CS signaling after the UE has camped onto the second RAT. In an aspect, the first RAT may include LTE and the second RAT may include at least one of a 2G RAT or a 3G RAT.

According to certain aspects, the PS signaling may include RAU related signaling, service request related signaling or any other NAS signaling. In some cases, resuming RAU related signaling upon completion of radio bearer setup (e.g., after radio bearer setup/complete steps 31/32 shown in FIG. 5) may reduce delay and overall impact on PS signaling.

FIG. 7 illustrates example operations 700 performed by a Base Station (BS) for improving call setup performance in accordance with certain aspects of the present disclosure. Operations 700 may begin, at 702, by detecting at least one of the occurrence or anticipated occurrence of circuit switched (CS) signaling by a user equipment (UE), wherein the CS signaling at least comprises signaling associated with a CS call setup procedure. At 704, the BS may suspend processing of PS signaling received from or associated with the UE in response to the detection. At 706, the BS may monitor progress of the CS call setup procedure. At 708, the BS may resume processing of the PS signaling on completion of a radio bearer setup step in the CS call setup procedure. In an aspect, the PS signaling may include RAU related signaling, service request related signaling or any other NAS signaling.

In certain aspects, the BS may determine that the UE has switched from a first RAT to a second RAT to service a CSFB call, and detect the CS signaling by the UE after the UE has camped onto the second RAT. In an aspect, the first RAT may include LTE and the second RAT may include at least one of a 2G RAT or a 3G RAT.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which may be a wired terminal or a wireless terminal. A terminal may also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

It should be understood and appreciated that various aspects or features will be presented in terms of systems that may include a number of devices, components, modules, and the like. It should also be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor may read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

As used herein, a phrase referring to “at least one of” a list of items refers to any combination of those items, including single members. As an example, “at least one of: a, b, or c” is intended to cover: a, b, c, a-b, a-c, b-c, and a-b-c.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of wireless communications by a user equipment (UE), comprising:
detecting at least one of occurrence or anticipated occurrence of circuit-switched (CS) signaling by the UE, wherein the CS signaling at least comprises signaling associated with a CS call setup procedure;
suspending packet-switched (PS) signaling by the UE in response to the detection;
monitoring progress of the CS call setup procedure; and
resuming the PS signaling on completion of a radio bearer setup step in the CS call setup procedure.

2. The method of claim 1, wherein the detecting comprises:
determining that the UE has switched from a first radio access technology (RAT) to a second RAT for a circuit-switched fallback (CSFB).

3. The method of claim 2, wherein the first RAT comprises a Long Term Evolution (LTE) RAT.

4. The method of claim 2, wherein the second RAT comprises at least one of a second generation (2G) RAT or a third generation (3G) RAT.

5. The method of claim 1, wherein the PS signaling includes routing area update signaling.

6. The method of claim 1, wherein the PS signaling includes service request signaling.

7. An apparatus for wireless communications by a user equipment (UE), comprising:
means for detecting at least one of occurrence or anticipated occurrence of circuit-switched (CS) signaling by the UE, wherein the CS signaling at least comprises signaling associated with a CS call setup procedure;
means for suspending packet-switched (PS) signaling by the UE in response to the detection;
means for monitoring progress of the CS call setup procedure; and
means for resuming the PS signaling on completion of a radio bearer setup step in the CS call setup procedure.

8. The apparatus of claim 7, wherein the means for detecting is further configured to:
determine that the UE has switched from a first radio access technology (RAT) to a second RAT for a circuit-switched fallback (CSFB).

9. The apparatus of claim 8, wherein the first RAT comprises a Long Term Evolution (LTE) RAT.

10. The apparatus of claim 8, wherein the second RAT comprises at least one of a second generation (2G) RAT or a third generation (3G) RAT.

11. The apparatus of claim 7, wherein the PS signaling includes routing area update signaling.

12. The apparatus of claim 7, wherein the PS signaling includes service request signaling.

13. An apparatus for wireless communications by a user equipment (UE), comprising:
at least one processor configured to:
detect at least one of occurrence or anticipated occurrence of circuit-switched (CS) signaling by the UE, wherein the CS signaling at least comprises signaling associated with a CS call setup procedure;
suspend packet-switched (PS) signaling by the UE in response to the detection;
monitor progress of the CS call setup procedure; and
resume the PS signaling on completion of a radio bearer setup step in the CS call setup procedure; and
a memory coupled to the at least one processor.

14. A computer program product for wireless communications by a user equipment (UE), comprising:
a computer-readable medium comprising code for:
detecting at least one of occurrence or anticipated occurrence of circuit-switched (CS) signaling by the UE, wherein the CS signaling at least comprises signaling associated with a CS call setup procedure;
suspending packet-switched (PS) signaling by the UE in response to the detection;
monitoring progress of the CS call setup procedure; and
resuming the PS signaling on completion of a radio bearer setup step in the CS call setup procedure.

15. A method of wireless communications by a base station (BS), comprising:
detecting at least one of occurrence or anticipated occurrence of circuit switched (CS) signaling by a user equipment (UE), wherein the CS signaling at least comprises signaling associated with a CS call setup procedure;
suspending processing of packet-switched (PS) signaling received from the UE in response to the detection;
monitoring progress of the CS call setup procedure; and
resuming processing of the PS signaling on completion of a radio bearer setup step in the CS call setup procedure.

16. The method of claim 15, wherein the detecting comprises:
determining that the UE has switched from a first radio access technology (RAT) to a second RAT for a circuit-switched fallback (CSFB).

17. The method of claim 16, wherein the first RAT comprises a Long Term Evolution (LTE) RAT.

18. The method of claim 16, wherein the second RAT comprises at least one of a second generation (2G) RAT or a third generation (3G) RAT.

19. The method of claim 15, wherein the PS signaling includes routing area update signaling.

20. The method of claim 15, wherein the PS signaling includes service request signaling.

21. An apparatus for wireless communications by a base station (BS), comprising:
means for detecting at least one of occurrence or anticipated occurrence of circuit switched (CS) signaling by a user equipment (UE), wherein the CS signaling at least comprises signaling associated with a CS call setup procedure;
means for suspending processing of packet-switched (PS) signaling received from the UE in response to the detection;
means for monitoring progress of the CS call setup procedure; and
means for resuming processing of the PS signaling on completion of a radio bearer setup step in the CS call setup procedure.

22. The apparatus of claim 21, wherein the means for detecting is configured to:
determine that the UE has switched from a first radio access technology (RAT) to a second RAT for a circuit-switched fallback (CSFB).

23. The apparatus of claim 22, wherein the first RAT comprises a Long Term Evolution (LTE) RAT.

24. The apparatus of claim 22, wherein the second RAT comprises at least one of a second generation (2G) RAT or a third generation (3G) RAT.

25. The apparatus of claim 21, wherein the PS signaling includes routing area update signaling.

26. The apparatus of claim 21, wherein the PS signaling includes service request signaling.

27. An apparatus for wireless communications by a base station (BS), comprising:
at least one processor configured to:
detect at least one of occurrence or anticipated occurrence of circuit switched (CS) signaling by a user equipment (UE), wherein the CS signaling at least comprises signaling associated with a CS call setup procedure;
suspend processing of packet-switched (PS) signaling received from the UE in response to the detection;
monitor progress of the CS call setup procedure; and
resume processing of the PS signaling on completion of a radio bearer setup step in the CS call setup procedure; and
a memory coupled to the at least one processor.

28. A computer program product for wireless communications by a base station (BS), comprising:
a computer-readable medium comprising code for:
detecting at least one of occurrence or anticipated occurrence of circuit switched (CS) signaling by a user equipment (UE), wherein the CS signaling at least comprises signaling associated with a CS call setup procedure;
suspending processing of packet-switched (PS) signaling received from the UE in response to the detection;
monitoring progress of the CS call setup procedure; and
resuming processing of the PS signaling on completion of a radio bearer setup step in the CS call setup procedure.
